(19) United States
(12) Patent Application Publication
(10) Pub. No.: US 2026/0120303 A1
(43) Pub. Date: Apr. 30, 2026

(54) TIME OF FLIGHT MESH COMPLETION

(71) Applicant: QUALCOMM Incorporated, San Diego, CA (US)

(72) Inventors: Himanshu JOSHI, San Diego, CA (US); Tung-Ting YANG, Taipei City (TW); Xiaoliang BAI, San Diego, CA (US)

(21) Appl. No.: 19/310,825

(22) Filed: Aug. 26, 2025

Related U.S. Application Data
(60) Provisional application No. 63/712,292, filed on Oct. 25, 2024.

(51) Int. Cl. G06T 7/50; G06T 17/00

(52) U.S. Cl. CPC G06T 7/50; G06T 17/00; G06T 2207/10028; G06T 2207/20221

(57) ABSTRACT

Techniques and systems are provided for generating a depth map. For instance, a process can include predicting a depth map based on an input image and active depth sensor information; generating a dilated mask by expanding an area indicating an availability of depth information in an active depth sensor depth mask, wherein the active depth sensor depth mask is generated using the active depth sensor information; filtering the predicted depth map to generate a revised predicted depth mask based on the dilated mask and the active depth sensor depth mask; and merging the revised predicted depth mask and an active depth sensor depth map to generate an output depth map.

### CROSS REFERENCE TO RELATED APPLICATIONS

This Application claims priority to U.S. Provisional Application No. 63/712,292, filed Oct. 25, 2024, the content of which is incorporated herein by reference in its entirety for all purposes.

### FIELD

This application is related to processing one or more images for extended reality systems. For example, aspects of the application relate to systems and techniques for time of flight (ToF) mesh completion, for example, for improving mesh generation.

### BACKGROUND

Extended reality (XR) systems or devices can provide virtual content to a user and/or can combine real-world or physical environments and virtual environments (made up of virtual content) to provide users with XR experiences. XR systems typically use powerful processors to perform feature analysis (e.g., extraction, tracking, etc.) and other complex functions quickly enough to display an output based on those functions to their users. Powerful processors generally draw power at a high rate. Powerful processors generally draw power at a high rate. Similarly, sending large quantities of data to a powerful processor typically draws power at a high rate. Headsets and other portable devices typically have small batteries so as not to be uncomfortably heavy to users. Thus, some XR systems must be plugged into an external power source, and are thus not portable.

In some cases, an XR system may capture images of a real environment in which the XR system is being used. By analyzing the images, the XR system may learn about the how the XR system is positioned in the real environment, for example, by mapping the environment to determine where the XR system is in relation to the real environment and how the position and pose of the XR system may change in relation to the real environment. Techniques that allow the XR system to understand more about the real environment in an energy efficient manner may be useful.

### SUMMARY

Systems and techniques are described herein for occlusion modeling based on images of an environment. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for an apparatus for generating a depth map is provided. The apparatus includes a memory comprising instructions; and a processor coupled to the memory. The processor is configured to: predict a depth map based on an input image and active depth sensor information; generate a dilated mask by expanding an area indicating an availability of depth information in an active depth sensor depth mask, wherein the active depth sensor depth mask is generated using the active depth sensor information; filter the predicted depth map to generate a revised predicted depth mask based on the dilated mask and the active depth sensor depth mask; and merge the revised predicted depth mask and an active depth sensor depth map to generate an output depth map.

As another example, a method for generating a depth map is provided. The method includes: predicting a depth map based on an input image and active depth sensor information; generating a dilated mask by expanding an area indicating an availability of depth information in an active depth sensor depth mask, wherein the active depth sensor depth mask is generated using the active depth sensor information; filtering the predicted depth map to generate a revised predicted depth mask based on the dilated mask and the active depth sensor depth mask; and merging the revised predicted depth mask and an active depth sensor depth map to generate an output depth map.

In another example, a non-transitory computer-readable medium having stored thereon instructions is provided. The instructions, when executed by at least one processor, cause the at least one processor to: predict a depth map based on an input image and active depth sensor information; generate a dilated mask by expanding an area indicating an availability of depth information in an active depth sensor depth mask, wherein the active depth sensor depth mask is generated using the active depth sensor information; filter the predicted depth map to generate a revised predicted depth mask based on the dilated mask and the active depth sensor depth mask; and merge the revised predicted depth mask and an active depth sensor depth map to generate an output depth map.

As another example, an apparatus for generating a depth map is provided. The apparatus includes: means for predicting a depth map based on an input image and active depth sensor information; means for generating a dilated mask by expanding an area indicating an availability of depth information in an active depth sensor depth mask, wherein the active depth sensor depth mask is generated using the active depth sensor information; means for filtering the predicted depth map to generate a revised predicted depth mask based on the dilated mask and the active depth sensor depth mask; and means for merging the revised predicted depth mask and an active depth sensor depth map to generate an output depth map.

In some aspects, the apparatus can include or be part of an extended reality device (e.g., a virtual reality (VR) device, an augmented reality (AR) device, or a mixed reality (MR) device), a mobile device (e.g., a mobile telephone or other mobile device), a wearable device (e.g., a network-connected watch or other wearable device), a personal computer, a laptop computer, a server computer, a television, a video game console, or other device. In some aspects, the apparatus further includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit data or information over a transmission medium to at least one device. In some aspects, the processor includes a central processing unit (CPU), a graphics processing unit (GPU), a neural processing unit (NPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example extended reality (XR) system, in accordance with some aspects of the disclosure.

FIG. 3 is a block diagram illustrating an example model generation system, in accordance with aspects of the present disclosure.

FIG. 4 is a block diagram illustrating an overview of ToF mesh completion, in accordance with aspects of the present disclosure.

FIG. 5 is a block diagram illustrating a dilated filling post processing, in accordance with aspects of the present disclosure.

FIG. 6 is a block diagram illustrating dark surfaces filling post processing, in accordance with aspects of the present disclosure.

FIG. 7 is an illustrative example of a neural network, in accordance with aspects of the present disclosure.

FIG. 8 is an illustrative example of a convolutional neural network (CNN), in accordance with aspects of the present disclosure.

FIG. 9 is a flow diagram illustrating an example of a process for occlusion prediction, in accordance with some aspects.

FIG. 10 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

A camera (e.g., image capture device) is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Degrees of freedom (DoF) refer to the number of basic ways a rigid object can move through three-dimensional (3D) space. In some cases, six different DoF can be tracked. The six degrees of freedom include three translational degrees of freedom corresponding to translational movement along three perpendicular axes. The three axes can be referred to as x, y, and z axes. The six degrees of freedom include three rotational degrees of freedom corresponding to rotational movement around the three axes, which can be referred to as pitch, yaw, and roll.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR systems can include virtual reality (VR) systems facilitating interactions with VR environments, augmented reality (AR) systems facilitating interactions with AR environments, mixed reality (MR) systems facilitating interactions with MR environments, and/or other XR systems. Examples of XR systems or devices include head-mounted displays (HMDs), smart glasses, among others. In some cases, an XR system can track parts of the user (e.g., a hand and/or fingertips of a user) to allow the user to interact with items of virtual content.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

To integrate XR content to a real-world view, an XR system may sense the environment around the XR system with one or more sensors. In some cases, the XR system may generate a 3D representation of the environment. This 3D representation may be displayed to a user of the XR system as a virtual representation of the environment and/or used by the XR system, for example, to place virtual objects in the environment or determine how virtual objects may virtually interact with objects in the real environment. In some cases, the 3D representation may be generated based on depth information for the environment. This depth information may be generated, for example, based on images captured by one or more image sensors (e.g., cameras) and active depth sensors, such as a ToF sensor. In some cases, active depth sensors may transmit a signal (e.g., light, radio frequency, infrared, laser, etc. beam) into the environment, receive a reflected and/or refracted version of the signal, and analyze the received version of the signal to determine depth information. In some cases, the depth information generated using an active depth sensor may be more accurate as compared to depth information determined from images alone (e.g., via stereoscopic vision techniques, monocular depth sensing techniques, etc.). In some cases, active depth sensors, such as a ToF sensor, may find certain surfaces more challenging, such as darker and/or more reflective surfaces. For example, as active depth sensors detect reflected/refracted signals transmitted from the sensor, how a surface reflects/refracts the transmitted signal can influence the determined depth information. As a more specific example, active depth sensors, such as ToF sensors, may have difficulties with darker colored and/or more reflective areas of the environment resulting in coverage holes corresponding to such areas. These holes in the depth map can degrade the 3D reconstruction, potentially resulting in holes in the 3D reconstruction corresponding to darker and/or reflective surfaces.

To avoid holes in the depth map resulting from, for example, darker and/or more reflective areas in the environment, active depth sensor data, such as ToF data, may be fused with image data and the fused data may be used to predict a depth map (e.g., a predicted depth map), for example, using ML based techniques. In such cases, depth information for those areas corresponding with areas the active depth sensors have difficulties with may be relatively less accurate as compared to areas where the active depth sensor have less difficulties with. In some cases, techniques to improve depth map generation for active depth sensors for generating a 3D mesh reconstruction may be useful.

Systems and techniques are described for improved ToF mesh completion, for example, by improving depth maps generated using active depth sensor data. For example, a predicted depth map may be improved via post processing of the active depth sensor data. In some cases, an active depth sensor depth map may be generated based on depth information and an active depth sensor depth mask may be generated based on the active depth sensor depth map. The active depth sensor depth mask may indicate pixels of the active depth sensor depth map which have associated active depth sensor depth information. A dilated mask may be generated by expanding an area around pixels of the active depth sensor depth mask associated with depth information. The predicted depth map may be masked based on the dilated mask to generate a revised predicted depth mask (which can also be referred to in some cases as a valid predicted depth mask). The revised predicted depth map may indicate areas of the predicted depth map which are expected to be relatively more reliable as they are near areas which have active depth sensor depth information. The revised predicted depth map may be merged with the active depth sensor depth map to generate an output depth map.

In some cases, to further improve the output depth map, a grayscale version of the image may be generated based on a captured image. A grayscale revised mask may be generated by applying a threshold intensity value to the grayscale version of the input image. The grayscale revised mask may indicate the regions of the input image that are relatively dark. The grayscale revised mask may be applied to a predicted depth map to generate a revised predicted depth map. In some cases, a distance filter may be applied to the predicted depth map to remove depth information greater than a threshold distance as depth information for distances further than the threshold distance may be less reliable. The revised predicted depth map may indicate which areas of the darker regions where the predicted depth map is expected to be more relatively more reliable (e.g., closer). The revised predicted depth map may be merged with the output depth map discussed above to generate a dark surfaces filled depth map for output.

Various aspects of the application will be described with respect to the figures.

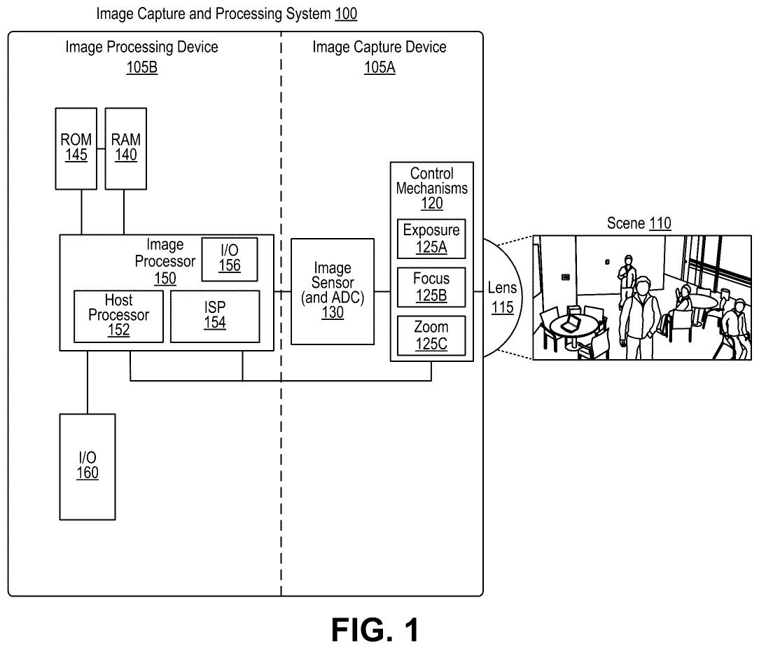

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

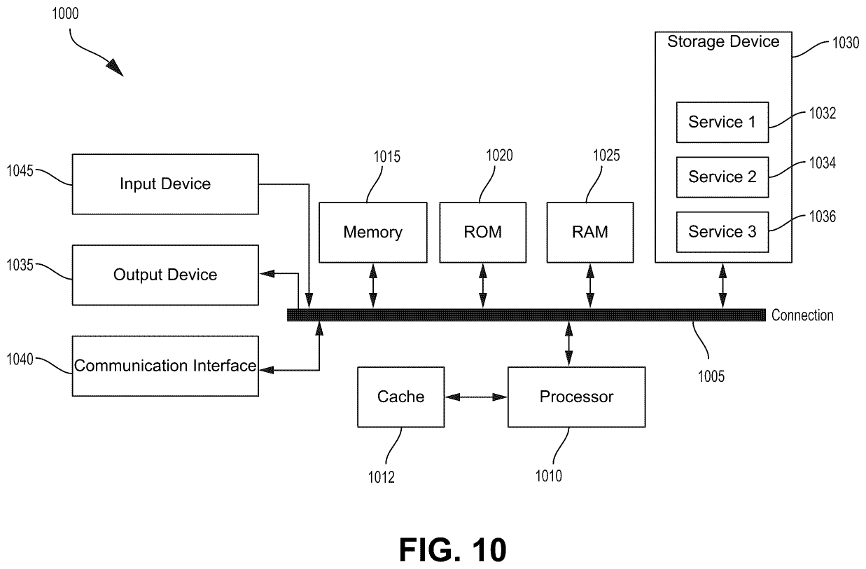

The image processor 150 may include one or more processors, such as one or more image signal processors (ISPs) (including ISP 154), one or more host processors (including host processor 152), and/or one or more of any other type of processor 1010 discussed with respect to the computing system 1000 of FIG. 10. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

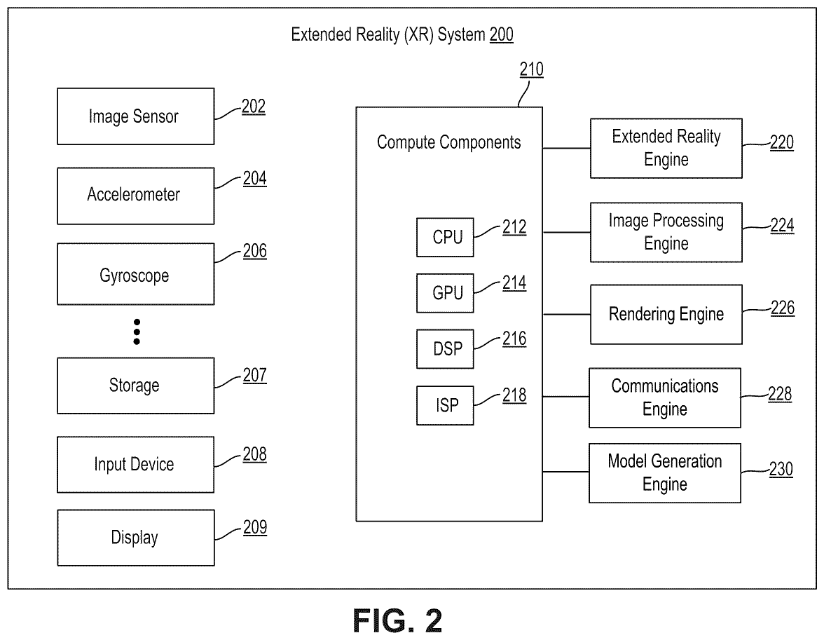

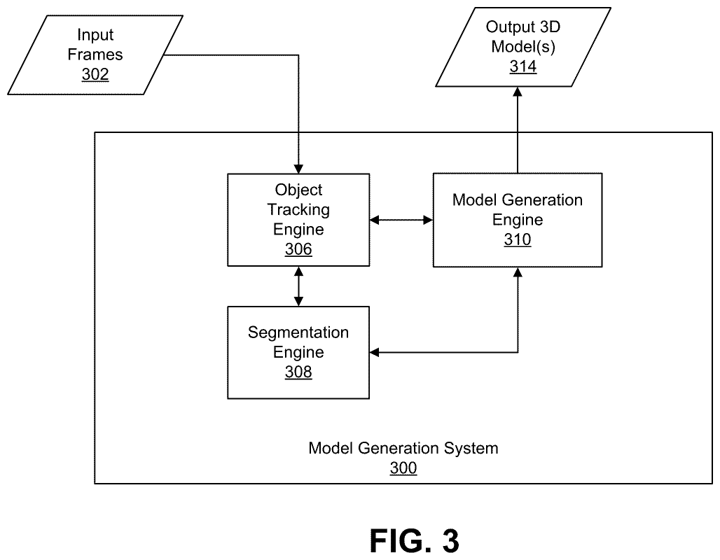

In some examples, the extended reality (XR) system 200 of FIG. 2 can include the image capture and processing system 100, the image capture device 105A, the image processing device 105B, or a combination thereof. In some examples, the model generation system 300 of FIG. 3 can be included with the image capture and processing system 100, the image capture device 105A, the image processing device 105B, or a combination thereof.

FIG. 2 is a diagram illustrating an architecture of an example extended reality (XR) system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a rendering engine 226, a communications engine 228, and a model generation engine 230. It should be noted that the components 202-230 shown in FIG. 2 are non-limiting examples provided for illustrative and explanation purposes, and other examples can include more, fewer, or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, the image sensor 202 can capture images that can be processed for interpreting gesture commands.

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1040 of FIG. 10.

In some cases, the XR system 200 may generate 3D reconstructions of objects and/or a scene using, for example, a sequence of frames of a target object and/or scene. For example, model generation engine 230 may be configured to obtain images and generate a 3D reconstruction of an object and/or scene based on the obtained images.

In some implementations, the one or more image sensors 202, the accelerometer 204, the gyroscope 206, storage 207, compute components 210, XR engine 220, image processing engine 224, rendering engine 226, communications engine 228, and model generation engine 230 can be part of the same computing device. For example, in some cases, the one or more image sensors 202, the accelerometer 204, the gyroscope 206, storage 207, compute components 210, XR engine 220, image processing engine 224, rendering engine 226, communications engine 228, and model generation engine 230 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, and rendering engine 226 can be part of two or more separate computing devices. For example, in some cases, some of the components 202-230 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, data from the rendering engine 226 (e.g., output frames), data from the communications engine 228, and/or data from the model generation engine 230 (e.g., 3D reconstructions). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, the rendering engine 226, and the model generation engine 230. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, the rendering engine 226, and/or the model generation engine 230 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 210 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 3 is a block diagram illustrating an example model generation system 300, in accordance with aspects of the present disclosure. The model generation system 300 provides a pipeline for closed object scanning. The model generation system 300 can be used as a stand-alone solution or can be integrated into existing 3D scanning solutions. As shown in FIG. 3, the model generation system 300 includes, an object tracking engine 306, a segmentation engine 308, and a model generation engine 310. As described in more detail below, the various components of the model generation system 300 can be used to perform object scanning by processing frames (e.g., input frames 302) of an object, and generating one or more 3D models of the object.

For example, the object tracking engine 306, and the segmentation engine 308 can perform a tracking-based object segmentation process. The segmentation engine 308 segments the object from other objects, such as a plane, allowing the model generation engine 310 to generate a 3D model (of one or more output 3D models 314) of the object without the plane associated with the planar surface. Using techniques described below, the model generation system 300 can detect irregular segmentation results, is robust against drifting that can occur during tracking, and can recover from segmentation failures.

The model generation system 300 can be part of, or implemented by, a single computing device or multiple computing devices. In some examples, the model generation system 300 can include or be part of a single electronic device, such as a mobile or telephone handset (e.g., smartphone, cellular telephone, or the like), an XR device such as an HMD or AR glasses, a camera system (e.g., a digital camera, an IP camera, a video camera, a security camera, etc.), a desktop computer, a laptop or notebook computer, a tablet computer, an Internet-of-Things (IoT) device, a set-top box, a television (e.g., a network or Internet-connected television) or other display device, a digital media player, a gaming console, a video streaming device, a drone or unmanned aerial vehicle, or any other suitable electronic device. In some examples, the model generation system 300 can include one or more wireless transceivers for wireless communications, such as cellular network communications, 802.11 wi-fi communications, wireless local area network (WLAN) communications, or some combination thereof. In some implementations, the model generation system 300 can be implemented as part of the computing system 1000 shown in FIG. 10.

While the model generation system 300 is shown to include certain components, one of ordinary skill will appreciate that the model generation system 300 can include more components than those shown in FIG. 3. The components of the model generation system 300 can include software, hardware, or one or more combinations of software and hardware. For example, in some implementations, the components of the model generation system 300 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the model generation system 300.

While not shown in FIG. 3, model generation system 300 can include various compute components. The compute components can include, for example and without limitation, a central processing unit (CPU), a graphics processing unit (GPU), a digital signal processor (DSP) (such as a host processor or application processor), and/or an image signal processor (ISP). In some cases, the one or more compute components can include other electronic circuits or hardware, computer software, firmware, or any combination thereof, to perform any of the various operations described herein. The compute components can also include computing device memory, such as read only memory (ROM), random access memory (RAM), Dynamic random-access memory (DRAM), one or more cache memory devices (e.g., CPU cache or other cache components), among other memory components.

The model generation system 300 can also include one or more input/output (I/O) devices. The I/O devices can include a display screen, a keyboard, a keypad, a touchscreen, a trackpad, a touch-sensitive surface, a printer, any other output devices, any other input devices, or any combination thereof. In some examples, the I/O devices can include one or more ports, jacks, or other connectors that enable a wired connection between the model generation system 300 and one or more peripheral devices, over which the system 300 may receive data from the one or more peripheral device and/or transmit data to the one or more peripheral devices. In some examples, the I/O devices can include one or more wireless transceivers that enable a wireless connection between the model generation system 300 and one or more peripheral devices, over which the system 300 may receive data from the one or more peripheral device and/or transmit data to the one or more peripheral devices. The peripheral devices may include any of the previously discussed types of I/O devices and may themselves be considered I/O devices once they are coupled to the ports, jacks, wireless transceivers, or other wired and/or wireless connectors.

As shown in FIG. 3, input frames 302 are input to the model generation system 300. Each frame of the input frames 302 captures an object positioned on a surface in a scene. An image capture device can capture the input frames 302 from different angles during an image capture process as the image capture device is moved around the object. For instance, a user can move the image capture device around the object as the input frames 302 are captured.

Each frame includes multiple pixels, and each pixel corresponds to a set of pixel values, such as depth values, photometric values (e.g., red-green-blue (RGB) values, intensity values, chroma values, saturation values, etc.), or a combination thereof. In some examples, the input frames 302 can include depth information in addition to or as an alternative to photometric values (e.g., RGB values). For instance, the input frames 302 can include depth maps (e.g., captured by a 3D sensor such as a depth sensor or camera), red-green-blue-depth (RGB-D) frames or images, among other types of frames that include depth information. RGB-D frames allow for the recording of depth information in addition to color and/or luminance information. In one illustrative example, a depth sensor can be used to capture multiple depth maps of the object from different angles. A depth map is an image or image channel (e.g., the depth channel in an RGB-D frame) that contains information indicating the distance of the surfaces of objects in a scene from a viewpoint such as the camera.

In some cases, performing a 3D reconstruction using an image-based depth estimation without using active depth sensors may result in an overall accuracy of about 8 to 12 cm at a 5 meter range. This accuracy may be improved by adding active depth sensors, such as a time of flight (ToF) sensor. In some cases, a ToF sensors may send out a light signal, such as provided by a laser, light emitting diode (LED), etc., into an environment and the ToF sensor measures an amount of time it takes for a reflection of the light signal to arrive back at the ToF sensor. A distance may then be determined based on the amount of time for the reflection to return to the ToF sensor. Using an active depth sensor, the overall accuracy of a 3D reconstruction can be improved to about 3 to 5 cm. However, this accuracy can be dependent on a reflectivity of a surface that the ToF sensors is trying to sense. For example, darker and more reflective surfaces can be challenging for ToF sensors to accurately measure as such surfaces have a reflectivity that can vary widely from other surfaces and an intensity of light reflected by such surfaces may be substantially lower as compared to other surfaces. In some cases, a 3D reconstruction of an environment with challenging surfaces can have holes in the reconstruction, which can degrade an overall user experience as such a reconstruction may appear incomplete and/or inaccurate. In some cases, techniques for ToF mesh completion may be useful to address areas of the reconstruction (e.g., mesh) which may appear incomplete.

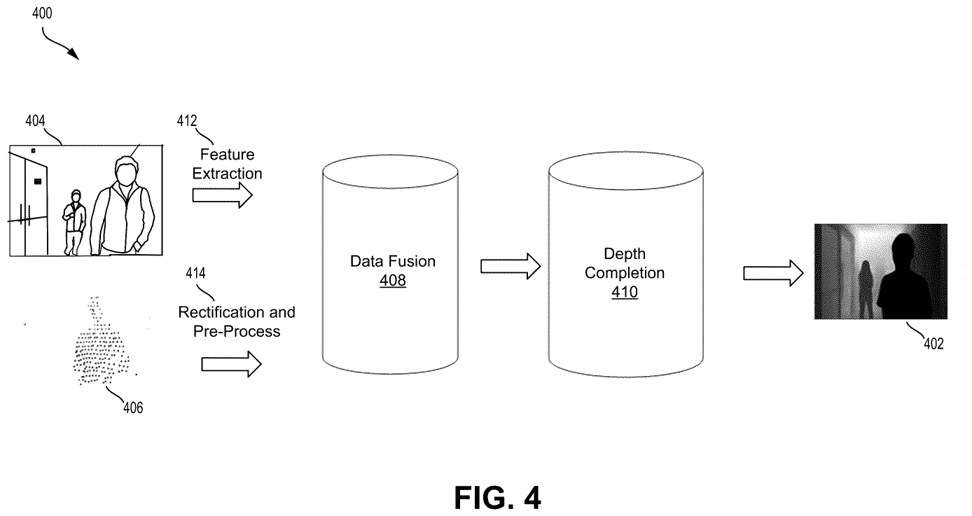

FIG. 4 is a block diagram illustrating an overview of ToF mesh completion 400, in accordance with aspects of the present disclosure. To provide a predicted depth map 402, images 404 may be obtained. The images 404 may be captured by one or more cameras and the images may be color images, grayscale images, or another type of image (e.g., infrared, ultraviolet, etc.). Image features may be extracted 412 from the images 404. In some cases, image feature extraction 412 may be performed using ML techniques, such as with a ML backbone or other ML trained to identify features of images.

The extracted 412 features may be combined with ToF data 406 (e.g., information generated by an active depth sensor such as a ToF sensor), via data fusion 408. In some cases, the ToF data 406 may have a same field of view (FoV) as the images 404. In some cases, the ToF data 406, extracted 412 features, and/or images 404 may be corrected such that they have corresponding intrinsic parameters and/or virtual camera poses. In some cases, the extracted 412 features, and/or images 404 may be adjusted to have a resolution corresponding to a nominal resolution (e.g., maximum resolution of the ToF sensor if all of the light beams of the ToF sensor are reflected back) of the ToF data 406. Depth completion 410 may be performed based on the combined ToF and image data. Depth completion 410 may be performed, for example, using a ML model trained to predict depth information for each pixel of the image 404 based on image features and partial ToF data 406. In some cases, the ToF data 406 may be rectified and/or preprocessed 414 prior to being combined with the extracted 412 features. Depth completion 410 may estimate a depth value for each pixel of the image and output the predicted depth map 402 indicating the depth information for use in 3D reconstruction.

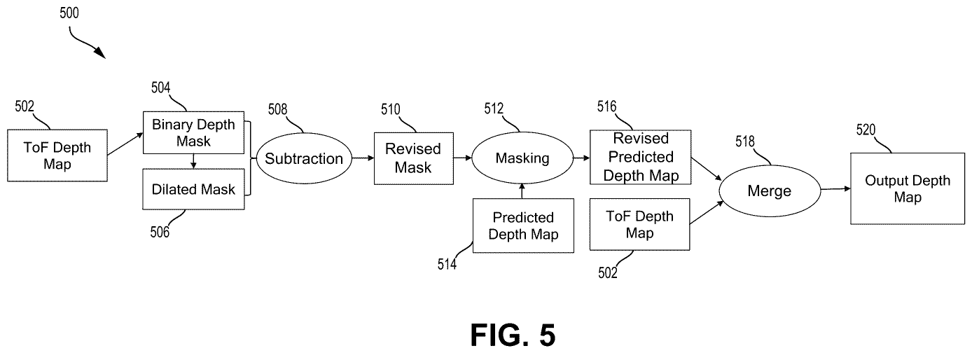

FIG. 5 is a block diagram illustrating a dilated filling 500 post processing, in accordance with aspects of the present disclosure. Dilated filling 500 may be used to provide better depth information for invalid/incomplete depth values for a depth map for pixels in proximity to pixels with valid ToF depth information. In some cases, these areas with invalid/incomplete ToF depth areas may correlate with darker and/or more reflective areas of the environment as captured in the images. In FIG. 5, a ToF depth map 502 may be generated for the ToF depth information. In some cases, the ToF depth information may correspond to the ToF data 406 of FIG. 4. The ToF depth map 502 may be generated based on an image (e.g., image 404 of FIG. 4), where each pixel of the ToF depth map 502 includes depth information indicating how far an object represented by a corresponding pixel in the image is from the camera.

Based on the ToF depth map 502, a binary depth mask 504 may be generated. The binary depth mask 504 may be a binary mask indicating which pixels of the ToF depth map 502 have depth information and which pixels of the ToF depth map 502 do not have depth information. For example, for the binary depth mask 504, pixels of the ToF depth map 502 with ToF depth information may be assigned a value of 1 and pixels of the ToF depth map 502 without ToF depth information may be assigned a value of 0. In some cases, the binary depth mask 504 may be replaced with another mask that uses non-binary masking, such as a gaussian distribution to provide a score or weight for masking.

A dilated mask 506 may be generated based on the binary depth mask 504. In some cases, dilation may be used to expand portions of the binary depth mask 504 correlated with regions with depth information into an area around a pixel with no depth information. For example, active depth sensors, such as ToF sensors, may measure and generate depth information for specific points in the environment and there may be less of these specific points (e.g., lower resolution) as compared to a resolution of the image. A depth mask (e.g., binary depth mask 504) based on the active depth sensor (e.g., active depth sensor depth mask) may indicate regions of the active depth sensor depth map (e.g., ToF depth map 502) in which measurements are made. As the active depth sensor depth information is used to generate the predicted depth map 514 (e.g., predicted depth map 402 of FIG. 4), the predicated depth map 514 may be relatively reliable in areas around the regions where active depth sensor depth information are available. In some cases, the active depth sensor depth mask may be modified into a dilated mask 506 to indicate portions of the predicated depth map which may be reliable.

The active depth sensor depth mask may indicate regions of the active depth sensor depth map in which active depth sensor measurements were made. These regions of the active depth sensor depth mask indicate that active depth sensor depth information (e.g., depth information) is available for these regions and these regions may be presumed reliable. The regions indicating available depth information may have a certain value in the active depth sensor depth mask, such as 1, and other areas in which depth information is not available may have another value, such as 0. To modify the active depth sensor depth mask to include areas where the predicated depth map is likely to be reliable that are around the regions indicating available depth information, the regions indicating available depth information in the active depth sensor depth mask may be expanded (e.g., dilated) to include areas where the predicated depth map is likely to be reliable. The resulting dilated mask 506 may then indicate portions of the predicated depth map which may be reliable.

As a more specific example, depth information may be available for a pixel p, and in the binary depth mask 504, pixel p may have a value of 1. Pixels around pixel p may not have a depth value and thus have a value of 0 in the binary depth mask 504. Expansion (e.g., dilation) may mark pixels in an area around pixel p with a value of 1, indicating that pixels in this area also have depth information. In some cases, a size of the area (e.g., via a kernel size and dilation multiplier may be tuned based on a depth completion ML model being used (e.g., depth completion 410 model of FIG. 4). Expanding the regions with depth information in the active depth sensor depth mask to generate the dilated mask may mark the area around the regions with depth information as being valid (e.g., not filtered, not masked out, having a value of 1 in the dilated mask 506, etc.), but does not necessarily copy the depth information from the active depth sensor depth map to the area expanded area around the regions with depth information.

The binary depth mask 504 may be subtracted 508 from dilated mask 506 to generate a revised mask 510. For example, pixels with ToF depth information, such as pixel p, may have a value of 0 (e.g., 1-1) in the revised mask 510, while pixels in a dilated area d may have a value of 1 (e.g., value of 1 in the dilated mask 506—value of 0 in the binary depth mask 504) in the revised mask 510, and invalid/incomplete depth values remain 0 in the revised mask 510.

A predicted depth map 514 may then be masked 512 using the revised mask 510 to generate a revised predicted depth map 516. Masking, or filtering, may be used to remove certain values from a set of values, such as pixel values for an image, and a mask may indicate which values should be removed (e.g., masked out, filtered, etc.). In some cases, the predicted depth map 514 may be predicted depth map 402 of FIG. 4. As discussed above, the predicted depth map 514 may be generated using one or more ML models and based on image features along with ToF information and the predicted depth map 514 may be relatively unreliable in areas without nearby ToF information. Masking 512 the predicted depth map 514 using the revised mask 510 may extract predicted depth information for the pixels in the dilated area for the revised predicted depth map 516. For example, pixel p may retain its ToF depth information, while pixels d around pixel p may be associated with depth information from the predicted depth map 514 as the predicted depth may be more accurate in an area around an obtained ToF depth. Predicted depth information from the predicted depth map 514 may also be used for invalid/incomplete area outside of pixels d and pixel p.

In some cases, the valid predicated depth map 516 may be merged with the ToF depth map 502. For example, a merge 518 operation may be performed with the revised predicted depth map 516 and the ToF depth map 502 to generate an output depth map 520. In some cases, the merge 518 operation may be a union operation. For example, the merge 518 operation may be a union between the ToF depth information from the ToF depth map 502 into the revised predicted depth map 516. For example, a depth value of pixel p in the output depth map 520 may be assigned based on the ToF depth information from the ToF depth map 502 in the output depth map 520.

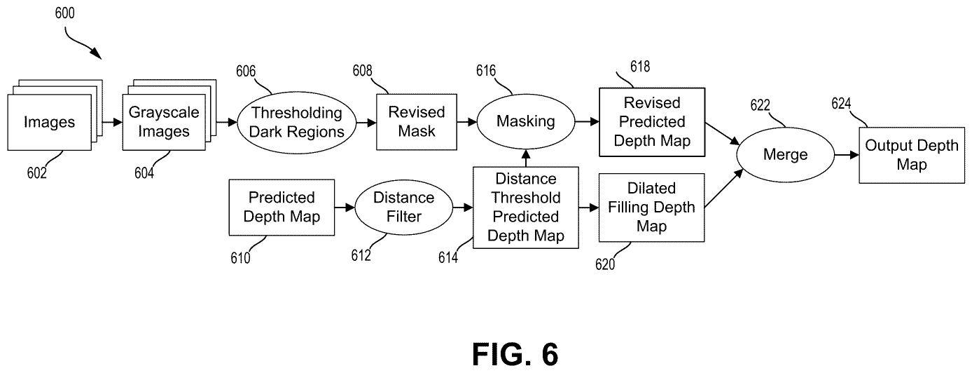

FIG. 6 is a block diagram illustrating dark surfaces filling 600 post processing, in accordance with aspects of the present disclosure. Dark surfaces filling 600 may be used to complete the depth map for areas that correlate with darker and/or more reflective areas of the environment as captured in the images 602 (e.g., images 404 of FIG. 4). In some cases, the images 602 may be color images (e.g., RGB images) and the color images 602 may converted to grayscale images 604 (e.g., grayscale luminance, intensity information, grayscale version of the color images 602).

Thresholding 606 may then be performed for the grayscale images 604. In some cases, darker regions in an image may have a lower intensity as compared to lighter regions and thresholding 606 may identify regions of the grayscale images 604 with an intensity value lower than a threshold intensity value (e.g., intensity value of 15, 30, 40, etc.) and generate a revised mask 608 indicating where the darker regions are. These darker areas may correlate with areas with a low reflectivity where the ToF sensor may have difficulties obtaining depth information. The revised mask 608 may be a binary mask. In some cases, areas with an intensity value lower than the threshold intensity (e.g., darker areas) may be marked with a 1 and areas with an intensity value greater than the threshold intensity (brighter areas) may be marked with a 0. In some cases, the threshold intensity may be a tunable value that may vary based on, for example, the ToF sensor.

A predicted depth map 610 may be obtained. The predicted depth map 610 may be substantially similar to the predicted depth map 514 of FIG. 5 and the predicted depth map 402 of FIG. 4. Distance filtering 612 may be performed for the predicted depth map 610 to generate a distance threshold predicted depth map 614. The distance filtering 612 may remove (e.g., filter) depth values further than a threshold distance, such as 2 m. In some cases, the threshold distance beyond which the distance filtering 612 may remove depth values may be set based on a distance where the error from the predicted depth map 610 may be more noticeable.

The distance threshold predicted depth map 614 may then be masked 616 using the revised mask 608 to generate a revised predicted depth map 618. The revised predicted depth map 618 may include the predicted depth information for those areas within the threshold distance and which are relatively darker (e.g., having an intensity value lower that the threshold intensity value).

A dilated filling depth map 620 may be obtained. In some cases, the dilated filling depth map 620 may be the output depth map 520 of FIG. 5 from dilated filling 500 post processing. In such cases, dark surfaces filling 600 post processing may be performed after dilated filling 500 post processing. In some cases, a ToF depth map, such as ToF depth map 502 of FIG. 2, or ToF data 406 of FIG. 4 may be used in place of the dilated filling depth map 620. A merge 622 operation may be performed with the revised predicted depth map 618 and the dilated filling depth map 620. In some cases, the merge 622 operation may be a union operation. The merge 622 operation may merge the revised predicted depth map 618 into the dilated filling depth map 620 to generate an output depth map 624 (e.g., dark surface filled depth map). The output depth map 624 may include the predicted depth information for those areas within the threshold distance and which are relatively darker as well as the dilated ToF depth information from rom dilated filling 500 post processing.

In some cases, while dilated filling 500 post processing and dark surfaces filling 600 post processing are described based on a single frame, dilated filling 500 post processing and dark surfaces filling 600 post processing may be performed using multiple frames to better resolve details, for example, in the darker regions.

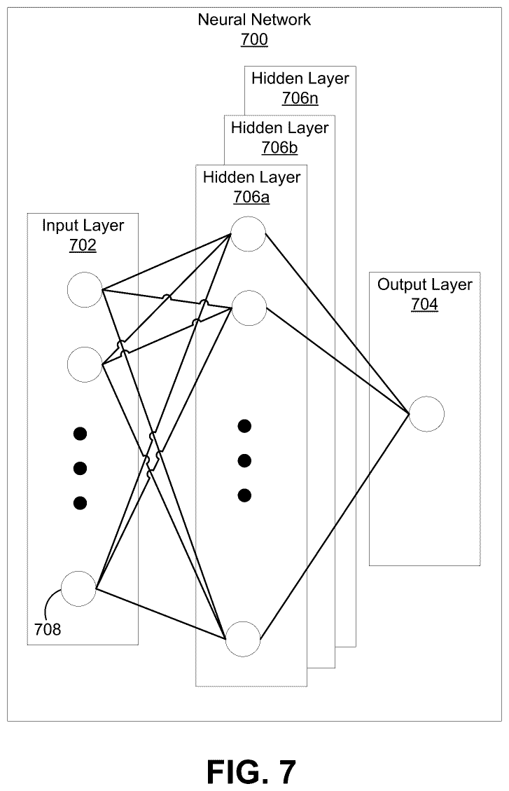

FIG. 7 is an illustrative example of a neural network 700 (e.g., a deep-learning neural network) that can be used to implement machine-learning-based image generation, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 700 may be an example of, or can implement, feature extraction 412 of FIG. 4, depth completion 410 of FIG. 4.

An input layer 702 includes input data. Neural network 700 includes multiple hidden layers hidden layers 706a, 706b, through 706n. The hidden layers 706a, 706b, through hidden layer 706n include “n” number of hidden layers, where “n” is an integer greater than or equal to one. The number of hidden layers can be made to include as many layers as needed for the given application. Neural network 700 further includes an output layer 704 that provides an output resulting from the processing performed by the hidden layers 706a, 706b, through 706n.

Neural network 700 may be, or may include, a multi-layer neural network of interconnected nodes. Each node can represent a piece of information. Information associated with the nodes is shared among the different layers and each layer retains information as information is processed. In some cases, neural network 700 can include a feed-forward network, in which case there are no feedback connections where outputs of the network are fed back into itself. In some cases, neural network 700 can include a recurrent neural network, which can have loops that allow information to be carried across nodes while reading in input.

Information can be exchanged between nodes through node-to-node interconnections between the various layers. Nodes of input layer 702 can activate a set of nodes in the first hidden layer 706a. For example, as shown, each of the input nodes of input layer 702 is connected to each of the nodes of the first hidden layer 706a. The nodes of first hidden layer 706a can transform the information of each input node by applying activation functions to the input node information. The information derived from the transformation can then be passed to and can activate the nodes of the next hidden layer 706b, which can perform their own designated functions. Example functions include convolutional, up-sampling, data transformation, and/or any other suitable functions. The output of the hidden layer 706b can then activate nodes of the next hidden layer, and so on. The output of the last hidden layer 706n can activate one or more nodes of the output layer 704, at which an output is provided. In some cases, while nodes (e.g., node 708) in neural network 700 are shown as having multiple output lines, a node has a single output and all lines shown as being output from a node represent the same output value.

In some cases, each node or interconnection between nodes can have a weight that is a set of parameters derived from the training of neural network 700. Once neural network 700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 700 to be adaptive to inputs and able to learn as more and more data is processed.

Neural network 700 may be pre-trained to process the features from the data in the input layer 702 using the different hidden layers 706a, 706b, through 706n in order to provide the output through the output layer 704. In an example in which neural network 700 is used to identify features in images, neural network 700 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 700 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 700 is trained well enough so that the weights of the layers are accurately tuned.

Neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 700 can include any other deep network other than a CNN, such as an autoencoder, a deep belief nets (DBNs), a Recurrent Neural Networks (RNNs), among others.

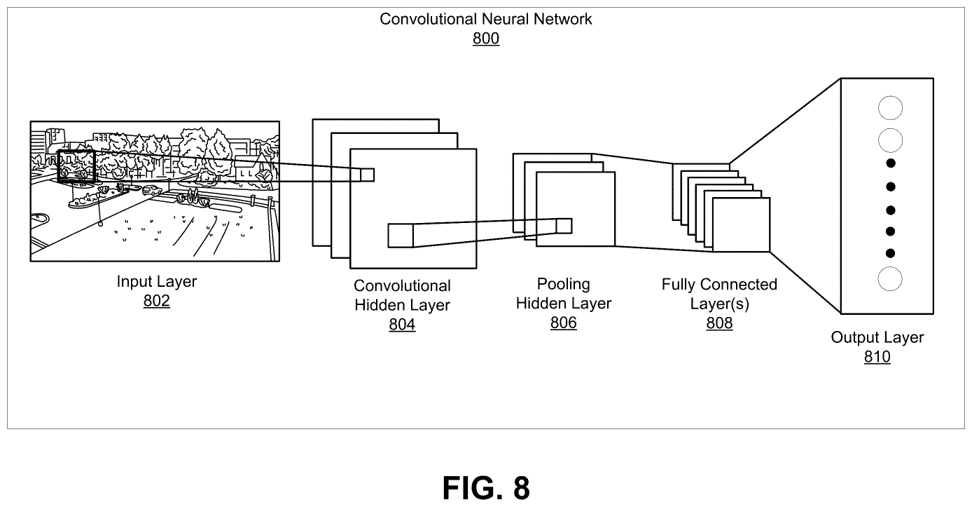

FIG. 8 is an illustrative example of a convolutional neural network (CNN) 800. The input layer 802 of the CNN 800 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 804, an optional non-linear activation layer, a pooling hidden layer 806, and fully connected layer 808 (which fully connected layer 808 can be hidden) to get an output at the output layer 810. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 can be the convolutional hidden layer 804. The convolutional hidden layer 804 can analyze image data of the input layer 802. Each node of the convolutional hidden layer 804 is connected to a region of nodes (pixels) of the input image called a receptive field. The convolutional hidden layer 804 can be considered as one or more filters (each filter corresponding to a different activation or feature map), with each convolutional iteration of a filter being a node or neuron of the convolutional hidden layer 804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 804. Each connection between a node and a receptive field for that node learns a weight and, in some cases, an overall bias such that each node learns to analyze its particular local receptive field in the input image. Each node of the convolutional hidden layer 804 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 804 is due to each node of the convolutional layer being applied to its corresponding receptive field. For example, a filter of the convolutional hidden layer 804 can begin in the top-left corner of the input image array and can convolve around the input image. As noted above, each convolutional iteration of the filter can be considered a node or neuron of the convolutional hidden layer 804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 804. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 804.

The mapping from the input layer to the convolutional hidden layer 804 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 804 can include several activation maps in order to identify multiple features in an image. The example shown in FIG. 8 includes three activation maps. Using three activation maps, the convolutional hidden layer 804 can detect three different kinds of features, with each feature being detectable across the entire image.

In some examples, a non-linear hidden layer can be applied after the convolutional hidden layer 804. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 804.

The pooling hidden layer 806 can be applied after the convolutional hidden layer 804 (and after the non-linear hidden layer when used). The pooling hidden layer 806 is used to simplify the information in the output from the convolutional hidden layer 804. For example, the pooling hidden layer 806 can take each activation map output from the convolutional hidden layer 804 and generates a condensed activation map (or feature map) using a pooling function. Max-pooling is one example of a function performed by a pooling hidden layer. Other forms of pooling functions be used by the pooling hidden layer 806, such as average pooling, L2-norm pooling, or other suitable pooling functions. A pooling function (e.g., a max-pooling filter, an L2-norm filter, or other suitable pooling filter) is applied to each activation map included in the convolutional hidden layer 804. In the example shown in FIG. 8, three pooling filters are used for the three activation maps in the convolutional hidden layer 804.

In some examples, max-pooling can be used by applying a max-pooling filter (e.g., having a size of 2×2) with a stride (e.g., equal to a dimension of the filter, such as a stride of 2) to an activation map output from the convolutional hidden layer 804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 804 having a dimension of 24×24 nodes, the output from the pooling hidden layer 806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 806 to every one of the output nodes in the output layer 810. Using the example above, the input layer includes 28×28 nodes encoding the pixel intensities of the input image, the convolutional hidden layer 804 includes 3×24×24 hidden feature nodes based on application of a 5×5 local receptive field (for the filters) to three activation maps, and the pooling hidden layer 806 includes a layer of 3×12×12 hidden feature nodes based on application of max-pooling filter to 2×2 regions across each of the three feature maps. Extending this example, the output layer 810 can include ten output nodes. In such an example, every node of the 3×12×12 pooling hidden layer 806 is connected to every node of the output layer 810.

The fully connected layer 808 can obtain the output of the previous pooling hidden layer 806 (which should represent the activation maps of high-level features) and determines the features that most correlate to a particular class. For example, the fully connected layer 808 can determine the high-level features that most strongly correlate to a particular class and can include weights (nodes) for the high-level features. A product can be computed between the weights of the fully connected layer 808 and the pooling hidden layer 806 to obtain probabilities for the different classes. For example, if the CNN 800 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 810 can include an M-dimensional vector (in the prior example, M=10). M indicates the number of classes that the CNN 800 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

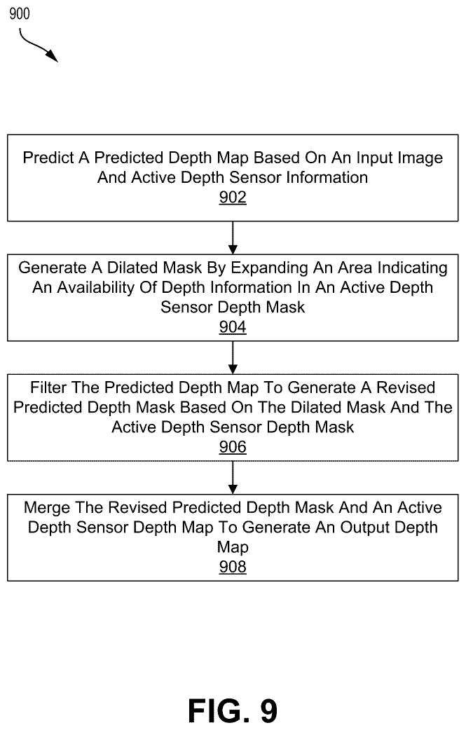

FIG. 9 is a flow diagram illustrating a process 900 for image generation, in accordance with aspects of the present disclosure. The process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device (e.g., XR system 200 of FIG. 2) such as a virtual reality (VR) device or augmented reality (AR) device, a vehicle or component or system of a vehicle, or other type of computing device (e.g., image capture and processing system 100 of FIG. 1, model generation system 300 of FIG. 3, computing system 1000 of FIG. 10, etc.). The operations of the process 900 may be implemented as software components that are executed and run on one or more processors.

At block 902, the computing device (or component thereof) may predict a depth map (e.g., predicted depth map 402 of FIG. 4) based on an input image (e.g., images 404 of FIG. 4) and active depth sensor information (e.g., ToF data 406 of FIG. 4). In some cases, the computing device (or component thereof) may include an active depth sensor.

At block 904, the computing device (or component thereof) may generate a dilated mask (e.g., dilated mask 506 of FIG. 5) by expanding an area indicating an availability of depth information in an active depth sensor depth mask (e.g., binary depth mask 504 of FIG. 5). In some cases, the active depth sensor depth mask is generated using the active depth sensor information. In some examples, the computing device (or component thereof) may generate a revised mask (e.g., revised mask 510 of FIG. 5) by subtracting (e.g., subtracted 508 of FIG. 5) the active depth sensor depth mask from the dilated mask; and filter the predicted depth map using the revised mask. In some examples, the computing device (or component thereof) may generate the active depth sensor depth map based on the depth information. In some cases, the active depth sensor depth mask comprises a binary mask indicating pixels of the active depth sensor depth map are associated with active depth sensor depth information.

At block 906, the computing device (or component thereof) may filter (e.g., mask 512 of FIG. 5) the predicted depth map to generate a revised predicted depth mask (e.g., revised predicted depth map 516 of FIG. 5) based on the dilated mask and the active depth sensor depth mask. In some cases, the computing device (or component thereof) may filter the predicted depth map using the revised mask by removing values or retaining values of the predicted depth map based on values of the revised mask.

At block 908, the computing device (or component thereof) may merge (e.g., merge 518 operation of FIG. 5) the revised predicted depth mask and an active depth sensor depth map to (e.g., ToF depth map 502 of FIG. 5) generate an output depth map. In some cases, the computing device (or component thereof) may output the output depth map. In some examples, the computing device (or component thereof) may generate a grayscale revised mask (revised mask 608 of FIG. 6) by applying a threshold intensity value (e.g., thresholding 606 of FIG. 6) to a grayscale version (e.g., grayscale images 604 of FIG. 6) of the input image; apply the grayscale revised mask to the predicted depth map to generate a revised predicted depth map (e.g., revised predicted depth map 618 of FIG. 6); and merge (e.g., merge 622 operation of FIG. 6) the revised predicted depth map with the output depth map to generate a dark surfaces filled depth map (e.g., output depth map 624 of FIG. 6). In some cases, the computing device (or component thereof) may output the dark surfaces filled depth map. In some examples, the computing device (or component thereof) may to apply the grayscale revised mask to the predicted depth map by filtering (e.g., distance filtering 612 of FIG. 6) the predicted depth map to remove distances further than a threshold distance to generate a distance threshold predicted depth map (e.g., distance threshold predicted depth map 614 of FIG. 6); and applying (e.g., masking 616 of FIG. 6) the grayscale revised mask to the distance threshold predicted depth map. In some cases, the input image comprises a color image (e.g., images 602 of FIG. 6). In some cases, the computing device (or component thereof) may generate the grayscale version of the input image using the input image.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 900 and/or other processes described herein may include a processor, microprocessor, micro-computer, or other component of a device that is configured to carry out the steps of the process 900 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 900 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 900 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some examples, computing system 1000 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, camera, accelerometers, gyroscopes, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASH EPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some examples, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for generating a depth map, comprising: at least one memory; and at least one processor coupled to the at least one memory, wherein the at least one processor is configured to: predict a depth map based on an input image and active depth sensor information; generate a dilated mask by expanding an area indicating an availability of depth information in an active depth sensor depth mask, wherein the active depth sensor depth mask is generated using the active depth sensor information; filter the predicted depth map to generate a revised predicted depth mask based on the dilated mask and the active depth sensor depth mask; and merge the revised predicted depth mask and an active depth sensor depth map to generate an output depth map.

Aspect 2. The apparatus of Aspect 1, wherein the at least one processor is further configured to output the output depth map.

Aspect 3. The apparatus of any of Aspects 1-2, wherein the at least one processor is further configured to: generate a revised mask by subtracting the active depth sensor depth mask from the dilated mask; and filter the predicted depth map using the revised mask.

Aspect 4. The apparatus of Aspect 3, wherein, to filter the predicted depth map using the revised mask, the at least one processor is configured to remove values or retain values of the predicted depth map based on values of the revised mask.

Aspect 5. The apparatus of any of Aspects 1-4, wherein the at least one processor is further configured to generate the active depth sensor depth map based on the depth information.

Aspect 6. The apparatus of any of Aspects 1-5, wherein the active depth sensor depth mask comprises a binary mask indicating pixels of the active depth sensor depth map are associated with active depth sensor depth information.

Aspect 7. The apparatus of any of Aspects 1-6, wherein the at least one processor is further configured to: generate a grayscale revised mask by applying a threshold intensity value to a grayscale version of the input image; apply the grayscale revised mask to the predicted depth map to generate a revised predicted depth map; and merge the revised predicted depth map with the output depth map to generate a dark surfaces filled depth map.

Aspect 8. The apparatus of Aspect 7, wherein the at least one processor is further configured to output the dark surfaces filled depth map.

Aspect 9. The apparatus of any of Aspects 7-8, wherein, to apply the grayscale revised mask to the predicted depth map, the at least one processor is further configured to: filter the predicted depth map to remove distances further than a threshold distance to generate a distance threshold predicted depth map; and apply the grayscale revised mask to the distance threshold predicted depth map.

Aspect 10. The apparatus of any of Aspects 7-9, wherein the input image comprises a color image and wherein the at least one processor is further configured to generate the grayscale version of the input image using the input image.

Aspect 11. The apparatus of any of Aspects-10, wherein the apparatus further comprises an active depth sensor.

Aspect 12. The apparatus of Aspect 11, wherein the active depth sensor comprises a time of flight sensor.

Aspect 13. A method for generating a depth map, comprising: predicting a depth map based on an input image and active depth sensor information; generating a dilated mask by expanding an area indicating an availability of depth information in an active depth sensor depth mask, wherein the active depth sensor depth mask is generated using the active depth sensor information; filtering the predicted depth map to generate a revised predicted depth mask based on the dilated mask and the active depth sensor depth mask; and merging the revised predicted depth mask and an active depth sensor depth map to generate an output depth map.

Aspect 14. The method of Aspect 13, further comprising outputting the output depth map.

Aspect 15. The method of any of Aspects 13-14, further comprising: generating a revised mask by subtracting the active depth sensor depth mask from the dilated mask; and filtering the predicted depth map using the revised mask.

Aspect 16. The method of Aspect 15, wherein filtering the predicted depth map using the revised mask comprises removing values or retaining values of the predicted depth map based on values of the revised mask.

Aspect 17. The method of any of Aspects 13-16, further comprising generate the active depth sensor depth map based on the depth information.

Aspect 18. The method of any of Aspects 13-17, wherein the active depth sensor depth mask comprises a binary mask indicating pixels of the active depth sensor depth map are associated with active depth sensor depth information.

Aspect 19. The method of any of Aspects 13-18, further comprising: generating a grayscale revised mask by applying a threshold intensity value to a grayscale version of the input image; applying the grayscale revised mask to the predicted depth map to generate a revised predicted depth map; and merging the revised predicted depth map with the output depth map to generate a dark surfaces filled depth map.

Aspect 20. The method of Aspect 19, further comprising outputting the dark surfaces filled depth map.

Aspect 21. The method of any of Aspects 19-20, wherein applying the grayscale revised mask to the predicted depth map comprises: filtering the predicted depth map to remove distances further than a threshold distance to generate a distance threshold predicted depth map; and applying the grayscale revised mask to the distance threshold predicted depth map.

Aspect 22. The method of any of Aspects 19-21, wherein the input image comprises a color image and further comprising generating the grayscale version of the input image using the input image.

Aspect 23. The method of any of Aspects 13-22, wherein a device includes an active depth sensor.

Aspect 24. The method of any of Aspects 23, wherein the active depth sensor comprises a time of flight sensor.

Aspect 25. A non-transitory computer-readable medium having stored thereon instructions that, when executed by at least one processor, cause the at least one processor to perform one or more operations according to any of Aspects 13-24

Aspect 26: An apparatus for generating a depth map, comprising means for performing one or more of operations according to any of Aspects 13 to 24.

What is claimed is:

1. An apparatus for generating a depth map, comprising:
at least one memory; and
at least one processor coupled to the at least one memory, wherein the at least one processor is configured to:
predict a depth map based on an input image and active depth sensor information;
generate a dilated mask by expanding an area indicating an availability of depth information in an active depth sensor depth mask, wherein the active depth sensor depth mask is generated using the active depth sensor information;
generate an active depth sensor depth map based on the depth information;
filter the predicted depth map to generate a revised predicted depth mask based on the dilated mask and the active depth sensor depth mask; and
merge the revised predicted depth mask and the active depth sensor depth map to generate an output depth map.

2. The apparatus of claim 1, wherein the at least one processor is further configured to output the output depth map.

3. The apparatus of claim 1, wherein the at least one processor is further configured to:
generate a revised mask by subtracting the active depth sensor depth mask from the dilated mask; and
filter the predicted depth map using the revised mask.

4. The apparatus of claim 3, wherein, to filter the predicted depth map using the revised mask, the at least one processor is configured to remove values or retain values of the predicted depth map based on values of the revised mask.

5. The apparatus of claim 1, wherein the active depth sensor depth mask comprises a binary mask indicating pixels of the active depth sensor depth map are associated with active depth sensor depth information.

6. The apparatus of claim 1, wherein the at least one processor is further configured to:
generate a grayscale revised mask by applying a threshold intensity value to a grayscale version of the input image;
apply the grayscale revised mask to the predicted depth map to generate a revised predicted depth map; and
merge the revised predicted depth map with the output depth map to generate a dark surfaces filled depth map.

7. The apparatus of claim 6, wherein the at least one processor is further configured to output the dark surfaces filled depth map.

8. The apparatus of claim 6, wherein, to apply the grayscale revised mask to the predicted depth map, the at least one processor is further configured to:
filter the predicted depth map to remove distances further than a threshold distance to generate a distance threshold predicted depth map; and
apply the grayscale revised mask to the distance threshold predicted depth map.

9. The apparatus of claim 6, wherein the input image comprises a color image and wherein the at least one processor is further configured to generate the grayscale version of the input image using the input image.

10. The apparatus of claim 1, wherein the apparatus further comprises an active depth sensor.

11. The apparatus of claim 10, wherein the active depth sensor comprises a time of flight sensor.

12. A method for generating a depth map, comprising:
predicting a depth map based on an input image and active depth sensor information;
generating a dilated mask by expanding an area indicating an availability of depth information in an active depth sensor depth mask, wherein the active depth sensor depth mask is generated using the active depth sensor information;
generating an active depth sensor depth map based on the depth information;
filtering the predicted depth map to generate a revised predicted depth mask based on the dilated mask and the active depth sensor depth mask; and
merging the revised predicted depth mask and the active depth sensor depth map to generate an output depth map.

13. The method of claim 12, further comprising outputting the output depth map.

14. The method of claim 12, further comprising:
generating a revised mask by subtracting the active depth sensor depth mask from the dilated mask; and
filtering the predicted depth map using the revised mask.

15. The method of claim 14, wherein filtering the predicted depth map using the revised mask comprises removing values or retaining values of the predicted depth map based on values of the revised mask.

16. The method of claim 12, wherein the active depth sensor depth mask comprises a binary mask indicating pixels of the active depth sensor depth map are associated with active depth sensor depth information.

17. The method of claim 12, further comprising:
generating a grayscale revised mask by applying a threshold intensity value to a grayscale version of the input image;
applying the grayscale revised mask to the predicted depth map to generate a revised predicted depth map; and
merging the revised predicted depth map with the output depth map to generate a dark surfaces filled depth map.

18. The method of claim 17, further comprising outputting the dark surfaces filled depth map.

19. The method of claim 17, wherein applying the grayscale revised mask to the predicted depth map comprises:
filtering the predicted depth map to remove distances further than a threshold distance to generate a distance threshold predicted depth map; and
applying the grayscale revised mask to the distance threshold predicted depth map.

20. The method of claim 17, wherein the input image comprises a color image, the method further comprising generating the grayscale version of the input image using the input image.
